(19) United States
(12) Patent Application Publication
(10) Pub. No.: US 2025/0381597 A1
(43) Pub. Date: Dec. 18, 2025

(54) PROCESS FOR PREPARING POWDER

(71) Applicant: L'Air Liquide, Societe Anonyme pour l'Etude et l’Exploitation des Procedes Georges Claude, Paris (FR)

(72) Inventors: Quentin MANDOU, Jouy en Josas (FR); Philippe LEFEBVRE, Jouy en Josas (FR); Lucie GUILLAUME, Jouy en Josas (FR)

(21) Appl. No.: 19/236,906

(22) Filed: Jun. 12, 2025

(30) Foreign Application Priority Data
Jun. 14, 2024 (FR) FRFR2406344

(51) Int. Cl. B22F 9/08

(52) U.S. Cl. CPC B22F 9/082; B22F 2009/0848; B22F 2009/0876; B22F 2301/205

(57) ABSTRACT

A preparation process for preparing powder from a first material and a second material, having a step of melting the first and second materials using an electric arc, a step of spraying the first and second molten materials in such a way as to form droplets, a step of cooling the droplets using a carrier gas so as to form solid particles, and a step of separating the solid particles from the carrier gas and collecting the solid particles so as to form the powder, the electric current applied to form the electric arc being a short circuit current.

### CROSS-REFERENCE TO RELATED APPLICATIONS

This application claims the benefit of priority under 35 U.S.C. § 119 (a) and (b) to French patent application No. FR2406344, filed Jun. 14, 2024, the entire contents of which are incorporated herein by reference.

### BACKGROUND

The present invention relates to a process for preparing powder, and more particularly to a process for preparing powder for an additive manufacturing process.

### FIELD OF THE INVENTION

Powder preparation processes are known from the prior art, for example electrode induction melting gas atomisation (EIGA). This process melts the material from a slowly rotating metal rod using a high-frequency induction coil. A stream of liquid is then formed which flows through an atomizing nozzle. The flow is then fragmented and solidified by a high velocity pulsed gas stream from the atomizing nozzle to form fine powder particles. These processes from the prior art are used to obtain spherical metal powders with limited pollution of the constituent material of the powders obtained. However, these processes, like the EIGA process, consume a lot of energy and are not simple to implement. Moreover, the particle size distribution of the powders obtained is not easy to control.

### RELATED ART

A process for preparing metal powders from a first material and a second material, the preparation process notably comprising a step of melting the materials using an electric arc, a step of spraying the molten materials in such a way as to form droplets, a step of cooling the droplets with a carrier gas in such a way as to form solid particles, and a step of separating the solid particles from the carrier gas and collecting the solid particles to form the powder, is also known from the application EP4221916A1.

It is not possible to obtain a satisfactory particle size distribution using this disclosed process, i.e. a particle size distribution that is sufficiently controlled. This powder thus produced requires additional separation steps and the process becomes expensive to implement in order to obtain a controlled particle size distribution, i.e. suited to the use of the powder intended by a user.

### SUMMARY OF THE INVENTION

The present invention is intended to effectively overcome the drawbacks of the prior art by proposing an improved powder preparation process which provides a powder with a better controlled particle size while obtaining a material quality which is compliant in terms of material composition.

The invention relates to a process for preparing powder from a first material and a second material, comprising:
a step of melting the first and second materials, using an electric arc formed by the application of an electric current between said first and second materials;
a step of spraying the first and second molten materials in such a way as to form droplets;
a step of cooling the droplets by means of a carrier gas so as to form solid particles;
a step of separating the solid particles from the carrier gas and collecting the solid particles so as to form the powder;
said preparation process being characterized in that said applied electric current is a short circuit current.

According to one embodiment, the short circuit electric current has a first voltage of between 10 V and 30 V, preferably between 11 V and 20 V, and more preferably between 14 V and 19 V.

According to one embodiment, the short circuit has a frequency of between 40 and 200 Hz.

According to one embodiment, the melting and spraying steps are carried out under inert gas, for example under argon, at a pressure between 4 and 12 bar, preferably between 6 and 10 bar.

According to one embodiment, the applied electric current has an intensity of between 50 and 400 A, preferably between 150 and 250 A, and more preferably between 180 and 220 A.

According to one embodiment, the first and second materials are dispensed at a dispensing speed and the intensity of the current is determined as a function of said dispensing speed of said first and second materials.

According to one embodiment, the first and second materials are dispensed at a speed of between 5 and 10 m/min.

According to one embodiment, the melting and spraying steps are repeated at least once and said applied electric current has a second voltage different from said first voltage of said applied current.

According to one embodiment, the preparation process comprises an additional step of analysing the powder to determine the density of said powder and/or the oxygen content of said powder and/or the particle size of said powder.

According to one embodiment, the preparation process comprises a step of enriching the droplets and/or the particles by means of an active substance which is carried out during the cooling step, the enriching step being preceded by a step of ionizing the active substance.

According to one embodiment, the enriching step is carried out during the spraying and cooling steps.

According to one embodiment, the cooling step is carried out using a cooling gas.

According to one embodiment, the active substance comprises:
at least one inert gas; and
at least one active compound comprising at least one of the following atoms: oxygen, nitrogen, carbon and hydrogen; each active compound being in the gaseous, liquid or solid phase, the content of each active compound being between 5 ppm and 20000 ppm.

### BRIEF DESCRIPTION OF THE FIGURES

The invention will be understood more clearly from reading the following description and from studying the accompanying figures. These figures are provided purely by way of illustration and do not in any way limit the invention.

FIG. 1 is a schematic view of a device implementing the invention.

FIG. 2 is a schematic view of a process for preparing the powders according to the invention.

FIG. 3 is a schematic view of the voltage and current values during the preparation process of one embodiment of the invention.

FIG. 4 is a schematic view of a dispensing device of the process of the invention.

### DETAILED DESCRIPTION OF THE INVENTION

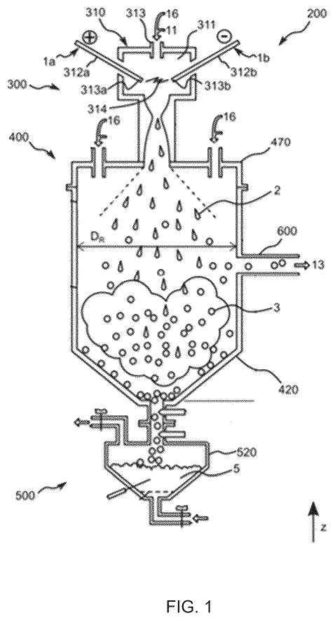

FIG. 1 shows a preparation device 200 configured to implement the preparation process 100 according to the invention. This preparation device 200 includes at least: a spraying means 300; an atomisation chamber 400; a first collection means 500; and an exhaust means 600. This preparation device 200 may also include complementary elements, not shown, such as: a gas/particle separation system; and a second collection means.

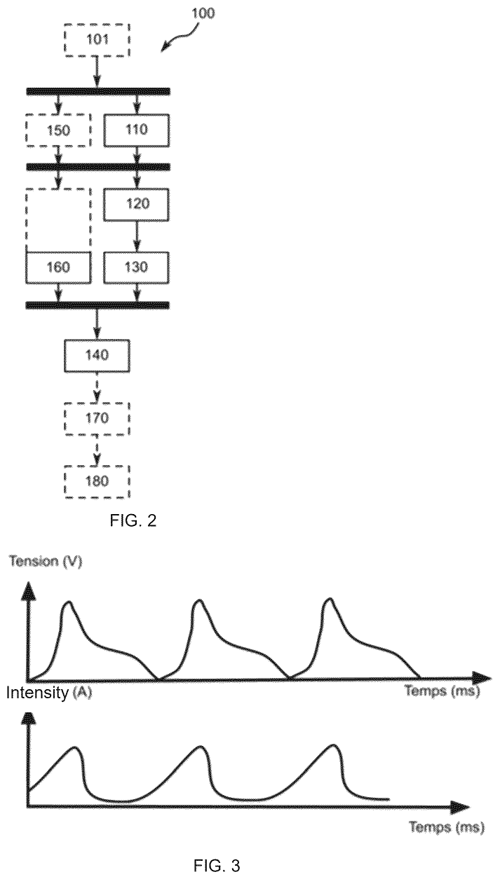

With reference to FIG. 2, the preparation process 100 comprises at least the following steps: a melting step 110 of melting two materials 1a, 1b using an electric arc 314; a spraying step 120 of spraying each material 1a, 1b in such a way as to form droplets 2; a cooling step 130 of cooling the droplets 2, using a carrier gas 11, so as to form solid particles 3; and a separation and collection step 140 of separating the particles 3 from the carrier gas 11 and collecting the solid particles 3 so as to form a first powder and a second powder 5, 6.

Each material 1a, 1b is an electrical conductor. It may, for example, be a pure metal such as titanium or aluminium or an alloy such as a titanium-based alloy, an aluminium-based alloy, a nickel-based alloy, a copper-based alloy or an iron-based alloy. The materials 1a, 1b may be of the same type or even identical. The choice of the composition of each material 1a, 1b partly determines the composition of the obtained powders 5, 6. In one embodiment, said first or second material is a Ti6Al4V alloy. These materials 1a, 1b are supplied in the form of conductive wires 312a, 312b, respectively, and dispensed towards the spraying means 300 shown in FIG. 1, and more specifically into the enclosure 311, by a feeding system, not shown, for example at a predefined speed. In one embodiment, the diameter of the wires 312a, 312b ranges between 0.8 and 2 mm, preferably between 1.2 and 2 mm. The wires can thus be easily handled.

During the melting step 110, this spraying means 300 is configured to carry out the melting step 110 of melting each material 1a, 1b using an electric arc 314. The spraying means 300 comprises an electric-arc source 310, also referred to as wire-arc torch. The wire-arc torch 310 is configured to generate an electric arc 314. The electric arc 314 may be created from the carrier gas 11, such as argon, nitrogen or helium, or a mixture of these gases. The wire-arc torch 310 comprises an enclosure 311 which is filled with the carrier gas 11 and in which the electric arc 314 is generated. The pressure of the carrier gas 11 in the enclosure 311 may be greater than or equal to atmospheric pressure. The wire-arc torch 310 is configured to generate the electric arc 314 between the first material 1a and the second material 1b. The wire-arc torch comprises the two conductive wires 312a, 312b, which are disposed one on each side of the enclosure 311, are mutually separate and are configured to trigger and sustain the electric arc 314 using the electric current. During operation, the distance between the two conductive wires 312a, 312b is preferably kept less than 5 mm and depends on the energy supplied. When the wire-arc torch 310 is in operation, the electric arc 314 is adjacent to the two facing ends 313a, 313b of the two wires 312a, 312b. The carrier gas 11 is introduced in jet form into the enclosure 311 through an inlet 313. The jet of carrier gas 11 is configured to strike the ends 313a, 313b of the two wires 312a, 312b. In one embodiment, the spraying means 300 comprises multiple wire-arc torches 310 for increasing the amount of powder produced by the preparation device 200. During this melting step 110, the mode of operation of the wire-arc torch 310 is chosen such that the temperature of the plasma at the electric arc 314 is greater than the melting temperature of each material 1a, 1b. Thus, during operation, said plasma causes the ends 313a, 313b of the two wires 312a, 312b to melt.

The spraying step 120 is also carried out using the spraying means 300. The spraying step 120 of spraying each material 1a, 1b from the liquefied ends 313a, 313b allows droplets 2 to form. During this spraying step 120, the jet of carrier gas 11 is focussed directly onto the liquefied ends 313a, 313b of the wires 312a, 312b such that the melted ends 313a, 313b are sprayed and droplets 2 are created. In order to maintain a fixed spacing between the ends 313a, 313b in spite of the spraying of material, the wires 312a, 312b are always introduced into the enclosure 311 by a feeding system, not shown, at a predefined speed.

FIG. 1 schematically shows the atomization chamber 400 and the exhaust means 600, which are configured in such a way as to carry out the cooling step 130 of cooling the droplets 2, using the carrier gas 11, such that solid particles 3 are formed. In one embodiment, in order to accelerate the cooling 130, a cooling gas 12 can be injected into the atomization chamber 400. The cooling gas 12 in contact with the carrier gas forms a gas mixture 13. Thus, during the cooling step 130, the droplets 2, which are in contact with the gas mixture 13, establish a transfer of heat with the gas mixture 13. Preferably, the temperature of the cooling gas 12 injected is chosen such that it is lower than the lowest of the solidification temperatures of the materials 1a, 1b or of the alloys formed by the materials 1a, 1b within the droplets 2. The cooling mixture 12 is, for example, injected at ambient temperature. As a result, the expanded carrier gas 11 and the cold cooling gas 12 cause heat to be transferred from the droplets 2 to the gas mixture 13, and this cools the droplets 2. When the temperature of the droplets 2 is lower than the solidification temperature of the droplets 2, the droplets 2 are solidified in such a way as to form the solid particles 3. The cooling step 130 allows the droplets 2 to form spheres, i.e. they adopt a spherical shape by virtue of the surface tension on the surface of the melted droplets 2 and the interaction with the gas mixture 13. Thus, as they solidify, the droplets 2 form particles 3 which have a sphericity greater than 0.9 and as close as possible to 1.

The preparation process 100 may also comprise an enriching step 160 of the droplets 2 or/and the particles 3. The enriching 160 is carried out by means of an active substance 16. The enriching 160 is at least implemented during the cooling step 130. However, the enriching 160 may also start during the spraying 120 and continue during the cooling 130. “Enriching” is understood to mean a metallurgical treatment of the materials 1a, 1b and of the alloys formed within the droplets 2 by means of an active substance 16 in such a way as to give the resulting particles 3 specific physico-chemical properties.

The active substance 16 implemented in the enriching step 160 comprises: at least one inert gas, advantageously of the same composition as the carrier gas 11; and at least one active compound comprising at least one of the following atoms: oxygen, nitrogen, carbon and hydrogen. Each active compound may be in the gaseous, liquid or solid phase, for example in the form of droplets or suspended particles. The content of each active compound within the active substance 16 ranges between 5 ppm and 20000 ppm and preferably between 5 ppm and 1000 ppm. It may, for example, be carbon monoxide or hydrogen. The active compound in the active substance 16 may be a hydrocarbon, such as methane, which is rich in carbon and hydrogen. If the active substance 16 comprises carbon monoxide or methane, the enriching 160 corresponds to a carburizing of the materials 1a, 1b. If the active substance 16 comprises nitrogen, the enriching 160 corresponds to a nitriding. If the active substance 16 comprises oxygen or hydrogen, the enriching 160 corresponds to an oxidation or, conversely, a reduction of the materials 1a, 1b. The active substance 16 may react with the materials 1a, 1b whether they are in the form of droplets 2 or solid particles 3. The active substance 16 is preferably injected into the atomization chamber 400 of the device 200. As a result, the active substance 16 reacts with the particles 3. Advantageously, the active substance 16 is involved in the spraying step 120. In this way, the active substance 16 reacts with the droplets 2. Alternatively, the active substance 16 is also injected at the spraying means 300. The partial pressures of the inert gas and of each active compound of the active substance 16 are monitored within the device 200 throughout the process 100 so that the content of each active compound remains between 5 ppm and 20000 ppm and preferably between 5 ppm and 1000 ppm. Since the chemical reactions take place between the active substance 16 and the surfaces of the droplets 2 and of the particles 3, it is possible to optimize the exchange surface area. In this way, the enriching step 160 is carried out efficiently. As a result, the enriching step 160 makes it possible to control the final chemical composition of the resulting particles 3.

Then, there is a separation and collection step 140 of separating the solid particles and collecting the solid particles 3 so as to form the powder 5, 6. This step is firstly carried out by the first collection means 500 which is connected to the atomization chamber 400. With reference to FIG. 1, the first collection means 500 comprises a main vessel 520 configured to receive a first portion of the solid particles 3 thus forming the powder 5. Then, a gas/particle separation system, not shown, is configured to separate the second portion of the particles 3 from the gas mixture 13. This second portion of particles is mainly formed of the lightest particles. The gas/particle separation system may, for example, be a filtration means, a settler or a cyclone.

In FIG. 2, the schematically shown preparation process 100 comprises several combinable steps, illustrated in dashed lines, which will now be described. An ionization step 150 can be combined with the enriching step 160 in order to improve the kinetics of the chemical reactions taking place between the droplets 2, the particles 3 and the active substance 16. The ionization step 150 comes before the enriching step 160, in which case the enriching step can start during the spraying 120. In this step, the active substance 16 may be introduced into the enclosure 311 of the spraying means 300 in such a way that it is ionized by the electric arc 314. The electric arc 314 ionizes each component of the active substance 16 so that reactive free ions are produced. The high-energy reactive free ions improve the reaction kinetics during the enriching step 160. The enriching reactions therefore balance before the droplets 2 are solidified. As a result, the chemical composition of the resulting particles 3 is controlled and reproducible. The concentration of reactive free ions is highest within the enclosure 311. Outside the enclosure, the concentration of reactive free ions decreases owing to the recombination reactions. Advantageously, the reactive free ions follow the path taken by the droplets 2 in the atomization chamber 400 in order to increase the duration of the enriching step 160.

At the end of the collection step 140, the passivation step 170 of passivating the surface of the particles 3 can be carried out, for example, if the first and second powders 5, 6 are prepared from materials that are flammable, i.e. have a strong affinity with oxygen. This is the case for example with powders 5, 6 formed from titanium, alloys of titanium or aluminium. The passivation step 170 is carried out using a passivation gas 14. The passivation gas 14 may for example comprise a noble gas and an active gas such as oxygen, the active gas preferably having a concentration of between 20 ppm and 2%. The passivation step 170 is carried out systematically on the two powders 5, 6. The following example will show the passivation step 170 carried out on the first powder 5 in the first collection means 500. The passivation step 170 can be transferred to the gas/particle separation system.

In order to obtain a first and a second powder 5, 6 that satisfy particle size distribution characteristics, an additional sieving step 180 may be carried out on the first and the second powder 5, 6. The sieving 180 makes it possible, for example, to remove aggregates of particles 3 or particles 3 that exceed a limit size from the powders 5, 6. The particle size distribution can be characterized by three specific diameters denoted D10, D50 and D90. 10% of the particles 3 have a diameter less than D10, 50% of the particles 3 have a diameter less than D50 and 90% of the particles 3 have a diameter less than D90. The sieving 180 may for example be carried out in order to adjust the distribution of the powders 5, 6, in particular the diameter D50, corresponding to the median of the distribution.

In order for the chemical composition of the powders 5, 6 to be reproducible, the preparation device 200 can undergo an additional inerting step 101. The inerting step 101 is carried out using an inerting gas and cycles of compression and expansion, in order to purge the air present in the device 200 until the oxygen content is less than 100 ppm, preferably less than 10 ppm, before starting the melting step 110. The inerting gas may for example comprise an inert gas or a mixture of inert gases.

Conventionally, in this process the transfer regimen used is a spray transfer regimen. This affords a continuous electric arc 314 by means of a continuous electric current during the melting and spraying steps. Moreover, a constant length of the electric arc 314 as the wire of material 1a, 1b is dispensed is obtained. However, the yields obtained by this powder preparation process are not satisfactory enough; specifically, the particle size distribution is not controlled enough. A possible result of this process is thus an excessive amount of fine particles, i.e. powders having a size of less than 1 micron. Furthermore, the inventors have noted that this process causes a sharp rise in temperature, and therefore the powder has a tendency to oxidize. In addition, sometimes the powder is sintered.

The inventors have thus sought to avoid these drawbacks. They then reduced the voltage of the electric current applied, while still keeping a constant supply of material, in order to reduce the length of the electric arc 314 and obtain powders 5, 6 of larger diameter. The transfer regime then changes to a short circuit transfer regime. In this short circuit regime, the inventors noted a considerable improvement in the control of the particle size distribution of the powders 5, 6. In this transfer regime, the electric current applied is no longer a continuous electric current—it is a short circuit current. As a result, during the melting step, the heat given off by the electric arc 314 makes the wire ends 313a, 313b melt until a droplet 2 is formed, and the two wires 312a, 312b will then be connected. A liquid bridge is also formed between the two wires 312a, 312b and the droplets 2. At this moment, a short circuit is created and the voltage of the electric current applied is then equal to 0 V. With reference to FIG. 3, the electric current applied is regulated by increasing the strength of the applied current. At this instant, the increase in the current strength, caused by the short circuit, generates electromagnetic fields which, together with the surface tension effect, will cut off the liquid bridge between the wires 312a, 312b and the droplet 2. The breaking of the bridge causes droplets 2 to spray out during the spraying step, these droplets 2 subsequently forming the powder 5, 6. Depending on the rate of the increase in current intensity, the formation of large droplets 2 is avoided. This means that the particle size distribution of the powders 5, 6 is better controlled. The powders 5, 6 produced comprise, in particular, less fine powder than the powders 5, 6 produced with a spray transfer regime. Furthermore, the powder is less polluted and the composition obtained is also better controlled. Indeed, the short circuit makes it possible to limit the rise in temperature. The phenomenon of oxidation of the powders is then less pronounced, and the composition is thus better controlled. Then, after the spraying of the droplets 2, the voltage is re-established, resulting in the re-creation of an electric arc 314 and the cycle of melting and spraying starts again.

In one embodiment, the voltage applied between the two conductive wires 312a, 312b can range between 10 V and 30 V, preferably between 11 V and 20 V, more preferably between 14 V and 19 V. The length of the electric arc 314 induced by the application of the electric current to the two materials 1a and 1b is smaller than it is for a spray transfer regime. These ranges of values make it possible to ensure a controlled particle size, i.e. a particle size distribution desired by the user of the process. Specifically, if the voltage is too low, the droplet 2 of metal can no longer drop off and the conductive wires 312a, 312b run the risk of becoming connected. There is then no short circuit. If the voltage is much too low, the electric arc 314 is not created and the wires 312a, 312b are fed without creating droplets. By contrast, if the voltage is too high, the particle size distribution of the powders and the composition of the powder will not be satisfactory. Specifically, the particle size of the powders can be excessively heterogeneous and/or include particles of powder 5, 6 that are excessively fine and have too small a diameter, for example have a size less than 1 micron. Furthermore, the quality of the powder may be adversely affected at high voltages and a condensation phenomenon can occur, generating nanoparticles that are sprayed out. The inventors have also observed, using a scanning electron microscope, that agglomerates of nanoparticles that have been sprayed out become attached to the surface of larger particles. These nanoparticles or sprayings increase the exchange surface area of the particles of powder 5, 6 produced and these sprayings thus contribute to increasing the oxygen content in the powder 5, 6 produced. The powder to be prepared is for example a Ti6Al4V powder, and the materials 1a and 1b are Ti6Al4V titanium alloys. In one embodiment of the Ti6Al4V powder, the voltage ranges between 15 and 19 V, preferably 16 V. It has been noted that this process makes it possible to obtain powders that meet the specifications defined in the ASTM F3001-14 and ASTM F2924-14 standards.

In one embodiment, the frequency of the short circuit ranges between 40 and 200 Hz. Moreover, if the voltage applied is increased, the frequency of the short circuit can be reduced. These frequency values make it possible to improve the quality of the powder 5, 6 developed. The powder to be prepared is for example a Ti6Al4V powder, and the materials 1a and 1b are Ti6Al4V titanium alloys. It has been noted that this process makes it possible to obtain powders that meet the specifications defined in the ASTM F3001-14 and ASTM F2924-14 standards. Furthermore, the particle size distribution is better controlled.

In one embodiment, said melting and spraying steps are carried out under inert gas, for example under argon, at a pressure P of between 4 and 12 bar. Reducing the pressure P increases the diameter of the droplets 2. Preferably in one embodiment, the pressure P is between 6 and 10 bar. This range of pressure P makes it possible in particular to obtain a particle size distribution suitable for the preparation processes that implement adapted metal powders, such as powder-bed laser melting or electron beam melting.

In one embodiment, the electric current applied between the two conductive wires 312a, 312b has a current strength of between 50 and 400 A, preferably between 150 and 250 A, more preferably between 180 and 220 A.

In one embodiment, the first and second materials 1a, 1b are dispensed at a dispensing rate and said current strength is determined as a function of said dispensing rate of said first and second materials 1a, 1b. This makes it possible to regulate the productivity of the preparation process.

In one embodiment, said first and second materials are dispensed at a rate of between 5 and 10 m/min. This reduces the mechanical stresses induced in the wire. Furthermore, if the rate is excessively high, the wire 312a, 312b will not have enough time to melt and if the rate is too low the electric arc 314 is interrupted.

In one embodiment, when said first voltage is equal to 0, the current strength increases between 100% and 150% during said spraying step.

In one embodiment, the melting and spraying steps are repeated at least once and said applied electric current has a second voltage different from said first voltage. This results in a perfectly controlled particle size of the powder prepared.

In one embodiment, the preparation process 100 comprises an additional step of analysing the powder to determine the density of said powder and/or the oxygen content of said powder and/or the particle size of said powder. As a result, the parameters of the process can be adjusted depending on the analysis of the powder.

A result obtained using the process according to the invention is now described below. In one example, the material 1a, 1b used is a Ti6Al4V titanium alloy. The regime used is a short circuit regime. The voltage of the electric current applied is fixed at 16 V. The target current strength is fixed at 200 A and the pressure P at 8 bar. The diameter of the wire used is 1.6 mm. The process has made it possible to obtain a powder 5, 6 which meets the specifications for compositions in the ASTM F3001-14 and ASTM F2924-14 standards, and the specifications for apparent density defined by the ASTM-B-212 standard or for flowability defined by the ASTM-B-213 standard. The process of the invention improves the control of the particle size distribution of the powders. As a result, at least 75% of the particles of the powders have a size less than 150 microns. Moreover, at least 50% of the particles of the powders have a size between 20 and 100 microns, which is the size of the powders usually used in additive manufacturing processes that implement metal powders. More particularly, more than 20% of the particles of powders 5, 6 have a size between 20 and 63 microns. This is a size suitable for powder-bed laser melting processes. More than 25% of the particles of powders 5, 6 have a size between 63 and 100 microns. This is a size suitable for electron beam melting processes.

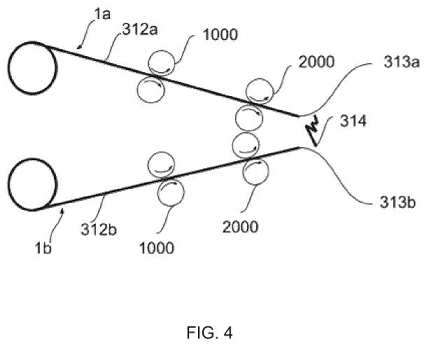

In one embodiment, the process of the invention comprises an additional dispensing step. With reference to FIG. 1 and FIG. 4, before the melting step, the wires 312a, 312b stored in the form of wire coils are each dispensed upstream of the preparation device 200 by a feeder 1000, for example rollers. The wires 312a, 312b are each dispensed in a dispensing direction, i.e. from the coil towards the electric arc 314. These feeders 1000 come after the coils in the dispensing direction. The feeders 1000 make it possible to push the wires 312a, 312b towards the preparation device 200.

Then, as close as possible to the electric arc 314, at least one additional feeder 2000 is added to the device for each wire 312a, 312b dispensed. The additional feeder 2000 makes it possible to stabilize the wire 312a, 312b by pulling it and then pushing it towards the electric arc 314, for example by means of rollers.

The feeder 1000 and the additional feeder 2000 together form a push-pull system. The wires 312a, 312b are thus pushed over a distance D in the dispensing direction. This distance D is the length measured between the feeder 1000 and the additional feeder 2000. Then, the wires 312a, 312b are drawn from the additional feeder 2000 towards the electric arc 314 in the dispensing direction. Then, the wires 312a, 312b are pushed from the additional feeder 2000 towards the electric arc 314, up to the ends of the wires 313a, 313b. The feeder 1000 and the additional feeder 2000 are synchronous, i.e. they dispense the wire at the same rate. This push-pull feeder reduces the oxygen uptake of the powder prepared using the process 100.

In one embodiment, said first wire 312a and said second wire 312b each have an end 313a, 313b which is melted during the melting step. Said first wire 312a and said second wire 312b are each pushed over a distance L, each distance L being equal to the length measured between said additional feeder 2000 and said respective ends 313a, 313b of the wires 312a, 312b. There are therefore fewer mechanical jolts on the wire 312a, 312b. Thus, the oxygen content in the powders 5, 6 prepared is lower than the oxygen content obtained without the process of the invention.

In one embodiment, said first wire 312a and said second wire 312b are pulled over a distance L equal to at least 1% of the distance D, preferably equal to at least 10% of the distance D. As a result, the tension of the wires 312a, 312b is well controlled. Moreover, the oxygen content in the powders 5, 6 prepared is lower than the oxygen content obtained without the process of the invention.

For example, the length of the wire between the feeding system and the electric arc 314 is 3 metres. The additional feeder is at a distance of between 20 and 50 cm from the ends 313a, 313b. A person skilled in the art will be able to easily adjust these distances on the basis of the teaching provided by the invention to obtain the desired effect, which is an oxygen content in the prepared powders 5, 6 which is lower than the oxygen content obtained without the process of the invention.

In one embodiment, the wires 312a, 312b are more particularly pushed through sheaths. The sheaths come after the feeder 1000 in the dispensing direction. The sheaths make it possible to guide the wires 312a and 312b, and to minimize the curvatures of the wires 312a, 312b. This guidance through the sheaths makes it possible to avoid deformations of the wires 312a, 312b and thus limit the stresses in the material 1a, 1b. In one embodiment, the sheaths are between the feeder 1000 and the additional feeder 2000, and this also reduces the friction in the sheaths. The dispensing of the wire is also better regulated.

In one embodiment, the wire feed rate ranges between 5 and 10 m/min.

In one embodiment, an additional step of straightening makes it possible to straighten the wires 312a, 312b by means of a wire straightener. As a result, the wires 312a, 312b are perfectly rectilinear, and are not deformed. The mechanical forces in the sheaths are lower. Moreover, the dispensing becomes easier. As a result, the electric arc 314 is well controlled, without interruption. Moreover, the quality of the powder in terms of composition is also well controlled. The particle size and the sphericity of the powders 5, 6 are better controlled.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A process for preparing powder from a first material and a second material, comprising:
melting the first and second materials, using an electric arc formed by the application of an electric current between said first and second materials;
spraying the first and second molten materials thereby forming droplets;
cooling the droplets using a carrier gas so as to form solid particles;
separating the solid particles from the carrier gas and collecting the solid particles thereby forming the powder;
wherein, during said melting step, a liquid bridge is formed between said first and second materials generating an increase in the intensity of the applied electric current and a voltage drop of the electric current to 0 V such that said applied electric current is a short circuit current.

2. The process according to claim 1, wherein said short circuit electric current has a first voltage of between 10 V and 30 V.

3. The process according to claim 1, wherein the short circuit has a frequency of between 40 and 200 Hz.

4. The process according to claim 1, wherein said melting and spraying steps are carried out under inert gas at a pressure (P) between 4 and 12 bar.

5. The process according to claim 1, wherein said applied electric current has an intensity of between 50 and 400 A.

6. The process according to claim 5, wherein said first and second materials are dispensed at a dispensing speed and said intensity of the current is determined as a function of said dispensing speed of said first and second materials.

7. The process according to claim 1, wherein said first and second materials are dispensed at a speed of between 5 and 10 m/min.

8. The preparation process according to claim 2, wherein said melting and spraying steps are repeated at least once and said applied electric current has a second voltage different from said first voltage of said applied current.

9. The process according to claim 1, further comprising an additional step of analysing the powder to determine the density of said powder and/or the oxygen content of said powder and/or the particle size of said powder.

10. The process according to claim 1, further comprising an enriching step of enriching the droplets and/or the particles by means of an active substance which is carried out during the cooling step, the enriching step being preceded by a step of ionizing the active substance.

11. The process according to claim 1, wherein the enriching step is carried out during the spraying and cooling steps.

12. The process according to claim 1, wherein the cooling step is carried out using a cooling gas in addition to the carrier gas.

13. The process according to claim 10, wherein the active substance comprises:
at least one inert gas; and
at least one active compound comprising at least one of the following atoms:
oxygen, nitrogen, carbon and hydrogen; each active compound being in the gaseous, liquid or solid phase, the content of each active compound being between 5 ppm and 20000 ppm.
